(19) United States
(12) Patent Application Publication
(10) Pub. No.: US 2019/0066417 A1
(43) Pub. Date: Feb. 28, 2019

(54) SYSTEM, METHOD, AND MEDIUM TO UNLOCK AN OBJECT

(71) Applicant: Alibaba Group Holding Limited, Georgetown (KY)

(72) Inventors: Kang WANG, Hangzhou (CN); Zhengbo WANG, Hangzhou (CN)

(21) Appl. No.: 16/118,194

(22) Filed: Aug. 30, 2018

(30) Foreign Application Priority Data
Aug. 31, 2017 (CN) 201710774379.5

(51) Int. Cl. G07C 9/00; H04B 10/50; H04B 10/60; H04L 29/08

(52) U.S. Cl. CPC G07C 9/00174; H04B 10/502; G07C 2009/00785; H04L 67/306; H04B 10/60

(57) ABSTRACT

A mobile computing device captures an image of an identification code on an object that identifies the object, extracts the code from the image, and forwards the code and a user ID to a server, which responds with digital key when the user ID has been verified. The mobile computing device converts the digital key into a pulsed light sequence that represents the digital key. An unlocking device attached to the object detects the pulsed light sequence, recovers the digital key from the pulsed light sequence, compares the recovered digital key to a pre-stored digital key, and unlocks the device when the recovered digital key matches the pre-stored digital key.

### CROSS-REFERENCE TO RELATED APPLICATIONS

This application claims priority to Chinese Patent Application No. 201710774379.5, filed on Aug. 31, 2017, which is incorporated herein by reference in its entirety.

### BACKGROUND OF THE INVENTION

### 1. Field of the Invention

The present application relates to the field of communications and, in particular, to a system, method, and medium for unlocking an object.

### 2. Description of the Related Art

The sharing economy has been booming in recent years. Examples include bikes, electric vehicles, power banks, and even cars. An important part of this business model is the technology of enabling users to unlock items. A current unlocking method requires the user to scan a two-dimensional barcode, such as on a vehicle, to obtain a vehicle ID, so that a server can query its key.

After this, the vehicle is unlocked via radio frequency communication with the server. However, this method of unlocking the vehicle through radio frequency communication requires the vehicle to be provided with a corresponding radio frequency communication module, which leads to a higher cost. Thus, there is a need for a lower cost approach to unlocking an object.

### SUMMARY OF THE INVENTION

The present invention provides a lower cost approach to unlocking an object. The present invention includes an unlocking system that includes a mobile computing device. The mobile comuting device obtains unlocking information, converts the unlocking information into a flashing sequence, and controls a light-emitting component of the mobile computing device to output the flashing sequence as a flashing light sequence. The unlocking system also includes a flash detecting device that detects the flashing light sequence, and outputs a flashing signal that varies in response to the flashing light sequence. The unlocking system further includes an unlocking device that is coupled to the flash detecting device. The unlocking device receives the flashing signal, extracts a digital key from the flashing signal, compares the digital key to a prestored digital key, and outputs an unlock signal when the digital key matches the prestored digital key.

The present invention also includes an unlocking method that includes obtaining unlocking information, and converting the unlocking information into a flashing sequence. The unlocking method also includes controlling a light-emitting component to output the flashing sequence as a flashing light sequence.

The present invention further includes a non-transitory computer-readable storage medium having embedded therein program instructions, which when executed by a processor causes the processor to execute a method of joining data tables. The method includes detecting a flashing light sequence, and outputting a flashing signal that varies in response to the flashing light sequence. The method also includes receiving the flashing signal, extracting a digital key from the flashing signal, comparing the digital key to a pre-stored digital key, and outputting an unlock signal when the digital key matches the pre-stored digital key.

A better understanding of the features and advantages of the present invention will be obtained by reference to the following detailed description and accompanying drawings which set forth an illustrative embodiment in which the principals of the invention are utilized.

### BRIEF DESCRIPTION OF THE DRAWINGS

The accompanying drawings described herein are used for providing further understanding of the present application and constitute a part of the present application. Exemplary embodiments of the present application and the description thereof are used for explaining the present application and do not constitute limitations on the present application.

FIG. 1 is a block diagram illustrating an example of a mobile device (or a computer terminal) 100 in accordance with the present invention.

FIG. 2 is a flow chart illustrating an example of a method 200 of unlocking an object in accordance with the present invention.

FIG. 3 is a flow chart illustrating an example of a method 300 of obtaining unlocking information in accordance with the present invention.

FIG. 4 is a flow chart illustrating an example of a method 400 of converting the unlocking information into a flashing sequence in accordance with the present invention.

FIGS. 5A-5B are a block-flow diagram illustrating an example of the interaction of a system 500 with a method 530 of unlocking an object in system 500 in accordance with the present invention.

FIGS. 6A-6C are diagrams illustrating an example of a mobile phone display 600 in accordance with the present invention. FIGS. 6A-6B illustrate display 600 while capturing a two-dimensional code. FIG. 6C illustrates display 600 with an alignment screen.

FIG. 7 shows a timing diagram illustrating an example of a voltage (V)-time (t) graph 700 in accordance with the present invention.

FIG. 8 is a flow chart illustrating an example of a method 800 of generating an unlocking instruction in accordance with the present invention.

FIG. 9 is a block diagram illustrating an example of a unlocking apparatus 900 in accordance with the present invention.

FIG. 10 is a block diagram illustrating an example of an unlocking apparatus 1000 in accordance with the present invention.

FIG. 11 is a diagram illustrating an example of an unlocking system 1100 in accordance with the present invention.

FIG. 12 is a block diagram illustrating an example of a computer terminal 1200 in accordance with the present invention.

### DETAILED DESCRIPTION OF THE INVENTION

In order to enable a person skilled in the art to better understand solutions of the present application, the technical solutions in the embodiments of the present application will be described clearly and completely below with reference to the drawings in the embodiments of the present application. It is apparent that the described embodiments are merely some, rather than all of the embodiments of the present application.

It should be noted that the terms “first”, “second”, and the like in the description and claims of the present application and in the above drawings are used to distinguish similar objects and are not necessarily used to describe a specific sequence or order. It should be understood that these numbers may be interchanged where appropriate so that the embodiments of the present application described herein can be implemented in orders other than those illustrated or described herein. In addition, the terms “include” and “have” and any variations thereof are intended to cover non-exclusive inclusions. For example, processes, methods, systems, products, or apparatuses that comprise a series of steps or units are not limited to steps or units that are clearly listed, but may include other steps or units not clearly listed or inherent to these processes, methods, products, or devices.

First, explanations of some terms used in the description of the present invention are provided.

CRC: Cyclic Redundancy Check is a hash function that generates short and fixed digits of check codes based on network data packets or computer files. It is mainly used to detect or check errors that may occur after data transmission or storage. It uses the principle of division and remainder for error detection.

RS code: also called Reed-Solomon codes, is a kind of forward error correction channel coding, which is effective for polynomials generated by corrected sampling data. When a receiver accurately receives enough points, it can restore the original polynomial even if many points on the received polynomial are distorted because of the noise interference.

Digital signature: also called public key digital signature or electronic signature, is a signature similar to a common physical signature written on paper, but it is implemented using the technology in the field of public key encryption so as to identify and differentiate digital information. A set of digital signatures usually define two complementary operations, with one for signature and the other for verification. A digital signature is a string of digits that can only be generated by the sender of the information and cannot be forged by others. This string of digits is also a valid proof to show the authenticity of the information sent by the sender of the information. Digital signature is an application of the asymmetric key encryption technology and the digital digest technology.

It should be noted that the steps shown in the flowcharts of the drawings may be performed in a computer system such as a set of computer-executable instructions. Although a logical order is shown in the flowcharts, in some cases, the illustrated or described steps may be performed in a different order other than the one shown here.

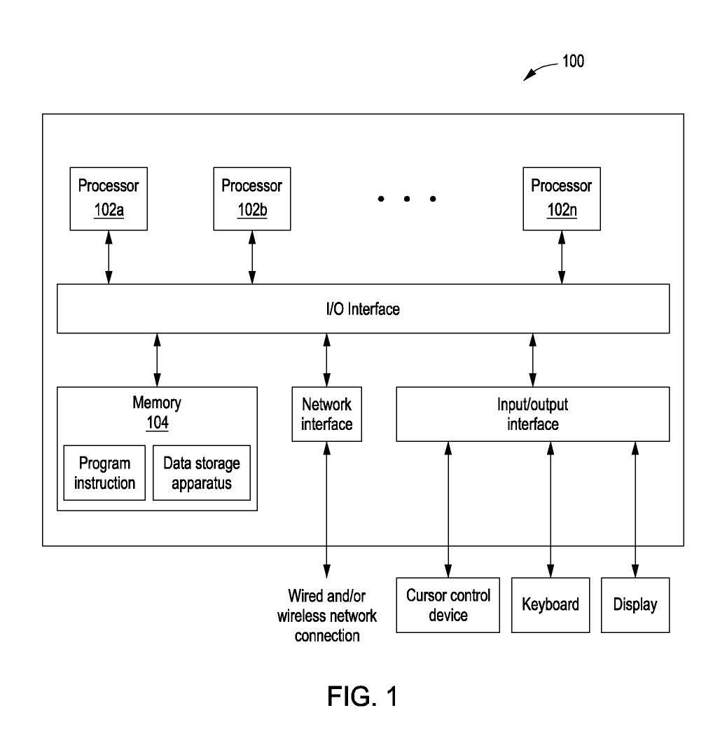

FIG. 1 shows a block diagram that illustrates an example of a mobile device (or a computer terminal) 100 in accordance with the present invention. As shown in FIG. 1, mobile device (or computer terminal) 100 includes one or more (shown as 102a, 102b, . . . , 102n in the figure) processors 102. Processor 102 may include, but is not limited to, a processing apparatus such as a microprocessor MCU or a programmable logic device FPGA.

As further shown in FIG. 1, mobile device (or computer terminal) 100 also includes a memory 104 for storing data, and a transmission module for communication. In addition, mobile device (or computer terminal) 100 may include: a display, an input/output interface (I/O interface), a universal serial bus (USB) port (which may be included as one of the ports for the I/O interface), a network interface, a power supply, and/or a camera. A person skilled in the art can understand that the structure shown in FIG. 1 is merely exemplary and does not limit the structure of the above electronic apparatus. For example, mobile device (or computer terminal) 100 may also include more or fewer components than those shown in FIG. 1, or may have a different configuration than that shown in FIG. 1.

The one or more processors 102 described above and/or other data processing circuits may generally be referred to herein as “data processing circuits.” A data processing circuit may be embodied in whole or in part as software, hardware, firmware, or any other combination. In addition, the data processing circuit may be a single, independent processing module, or may be incorporated in whole or in part into any of the other elements in mobile device (or computer terminal) 100. As involved in the embodiments of the present invention, the data processing circuit is used as a processor control (e.g., controlling for a selection of a variable resistance terminal path connected to an interface).

Memory 104 may be configured to store software programs and modules of an application software, such as program instructions/data storage apparatuses corresponding to the unlocking method in this embodiment of the present invention. Processor 102 executes the software programs and modules stored in memory 104 so as to execute various functional applications and data processing, i.e., implementing the above method for detecting bugs of the application programs. Memory 104 may include a high-speed random access memory, and may also include a non-volatile memory such as one or more magnetic storage devices, flash memory, or other non-volatile solid-state memories. In some examples, memory 104 may further include memories remotely arranged with respect to processor 102. The remote memories may be connected to mobile device (or computer terminal) 100 via a network. Examples of such networks include, but are not limited to, the Internet, intranets, local area networks, mobile communication networks, and the combinations thereof.

The transmission apparatus is configured to receive or transmit data via a network. A specific example of the network may include a wireless network provided by a communication provider of mobile device (or computer terminal) 100. In an example, the transmission apparatus includes a network interface controller (NIC) that can be connected to other network devices through a base station so that the transmission apparatus can communicate with the Internet. In one example, the transmission apparatus may be a radio frequency (RF) module for wirelessly communicating with the Internet. The display may be, for example, a touch-screen liquid crystal display (LCD), which may enable a user to interact with a user interface of mobile device (or computer terminal) 100.

In some alternative embodiments, mobile device (or computer terminal) 100 shown in FIG. 1 may include hardware elements (including circuits), software elements (including computer codes stored on a computer-readable medium), or a combination of hardware elements and software elements. FIG. 1 is merely one example of a mobile device (or computer terminal), and is intended to show the types of components that may be provided in a mobile device (or computer terminal).

In such a business scenario, the applicant has found that almost all smart phones are provided with light emitting components (such as a flash). Therefore, the present application enables the unlock of an item by using the emitted flash signal of a light emitting component within the smart phone. As a result, the items do not need to be provided with corresponding radio frequency communication modules, so as to achieve the purpose of reducing operating costs.

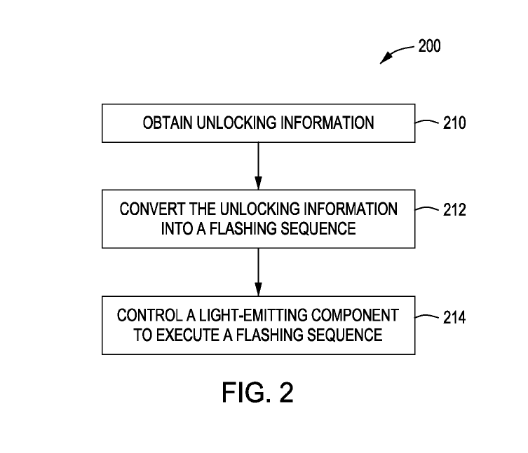

FIG. 2 shows a flowchart that illustrates an example of a method 200 of unlocking an object in accordance with the present invention. As shown in FIG. 2, method 200 begins at 210 by obtaining unlocking information. The unlocking information may be obtained from a server, and the unlocking information may specifically include a digital key for a to-be-unlocked object.

The to-be-unlocked object needs to be unlocked before a user can use the to-be-unlocked object. First, the user needs to obtain identification information of the to-be-unlocked object. For example, the user can obtain an ID of the to-be-unlocked object by scanning a two-dimensional barcode on the to-be-unlocked object via a mobile phone.

Next, the obtained ID of the to-be-unlocked object and user identity information are transmitted to the server so as to initiate an unlocking request. After authenticating the uploaded information (the ID of the to-be-unlocked object and the user identity information), the server determines whether the unlocking request is a legitimate request. If it is determined that the request is legitimate, the server delivers the unlocking information (such as the digital key) to the mobile phone of the user.

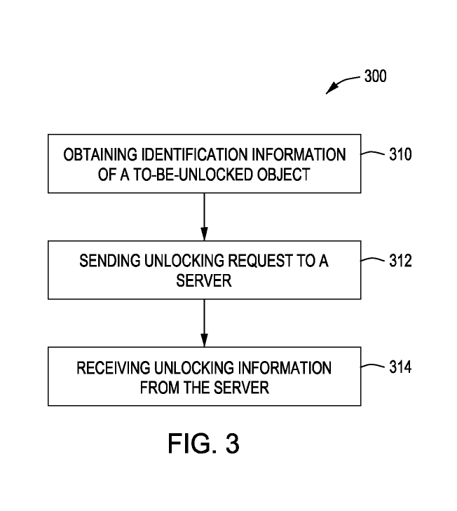

FIG. 3 shows a flow chart that illustrates an example of a method 300 of obtaining unlocking information in accordance with the present invention. As shown in FIG. 3, method 300 begins at 310 by obtaining identification information of a to-be-unlocked object. The identification information of the to-be-unlocked object may be an ID of the to-be-unlocked object that the user obtains after scanning a two-dimensional barcode on the to-be-unlocked object through the user's mobile device (such as a mobile phone). Each to-be-unlocked object corresponds to only one piece of identification information.

Next, method 300 moves to 312 to send an unlocking request to a server. After obtaining the identification information of the to-be-unlocked object, the mobile device generates the unlocking request and transmits the unlocking request to the server. The unlocking request carries the identification information and the user identity information. The user identity information may include a user name, account information, and the like. After receiving the unlocking request, the server determines, according to the identification information and the user identity information, whether the unlocking request is a legitimate request. The server then generates the unlocking information when it is determined, based on the identification information and the user identity information, that the unlocking request is legitimate.

Following this, method 300 moves to 314 to receive the unlocking information returned by the server. After generating the unlocking information, the server returns the unlocking information to the mobile device.

Referring back to FIG. 2, after the unlocking information has been obtained, method 200 moves to 212 to convert the unlocking information into a flashing sequence. After the unlocking information for the to-be-unlocked object is obtained, the unlocking information is converted into the flashing sequence. The flashing sequence is used to indicate a flashing action of a light-emitting component, which can be a flashlight of the terminal.

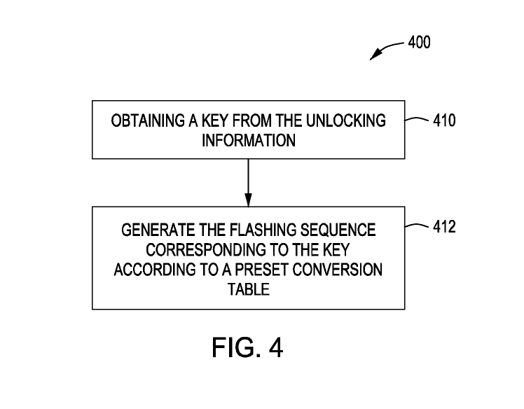

FIG. 4 shows a flow chart that illustrates an example of a method 400 of converting the unlocking information into a flashing sequence in accordance with the present invention. As shown in FIG. 4, method 400 begins at 410 by obtaining a digital key from the unlocking information. In the process of converting the unlocking information into the flashing sequence, a digital key is extracted first from the unlocking information. Here Morse Code is used as an example. Assuming that the digital key for unlocking the to-be-unlocked object is 3271.

Next, method 400 moves to 412 to generate the flashing sequence corresponding to the digital key according to a preset conversion table. The preset conversion table has been previously generated, which may include a corresponding relationship between the key and the flashing sequence. As shown in table 1:

TABLE 1

| Digit | The flashing sequence |
|---|---|
| 1 | .---- |
| 2 | ..--- |
| 3 | ...-- |
| 4 | ....- |
| 5 | ..... |
| 6 | -.... |
| 7 | --... |
| 8 | ---.. |
| 9 | ----. |
| 0 | ----- |

“.” indicates a short light pulse such as 10 ms. “-” indicates a light pulse that lasts for a longer time such as 30 ms. An interval between “.” and “-” may be 10 ms, and an interval between digitals may be 30 ms. The light pulse refers to a flashing action of the light-emitting component.

Here the key 3271 is still used as an example for illustration. The preset conversion table is used here to find the flashing sequences. The corresponding flashing sequence for “3” is “...--”; the corresponding flashing sequence for “2” is “..---”; the corresponding flashing subsequence for “7” is “--...”; and the corresponding flashing sequence for “1” is “.----”. On such basis, the flashing sequence corresponding to the key may be generated as follows:

“...--

..---

--..

.----”

This embodiment exemplarily illustrates a method for generating a flashing sequence corresponding to a digital key by looking up a preset conversion table. Alternately, a flashing sequence can be generated by using other conversion methods, like converting according to a preset rule, all of which shall fall within the protection scope of this embodiment.

In addition, the pulse number modulation may also be used. The key 3271 is still used as an example. The converted flashing sequence is as follows:

“...

..

.......

.”

Each “.” represents a light pulse that lasts, for example, for 10 ms, and the interval between each set of numbers is 30 ms.

It should be noted that there are many other solutions for converting a key into a flash sequence, which are all designed to control a light-emitting component to emit a flashing signal according to a certain rule so as to achieve unlocking of the to-be-unlocked object, which is not limited to this embodiment.

Referring back to FIG. 2, after the unlocking information has been converted into a flashing sequence, method 200 moves to 214 to control the light-emitting component to execute the flashing sequence. For example, the light-emitting component can be controlled to emit a flashing signal with a flashing duration according to a flashing frequency, where the flashing sequence includes the flashing frequency and the flashing duration.

After the flashing sequence has been generated, the user is prompted on the interaction interface to align the light-emitting component (such as the flashlight) with the flash-receiving apparatus (such as a solar cell). Further, the status or output of the flash-receiving apparatus changes under the influence of the light-emitting component, and the unlocking apparatus unlocks the to-be-unlocked object by detecting the change.

Using the above Morse Code as an example, the generated flashing sequence is as follows:

“...--

..---

--..

.----”

The flashing sequence indicates the flashing frequency and the flashing duration. For example, “.” indicates a short light pulse such as 10 ms. “-” indicates a light pulse that lasts for a longer time such as 30 ms; an interval between “.” and “-” may be 10 ms, and an interval between digitals may be 30 ms. Based on the flashing sequence, the light-emitting component is controlled to emit the flashing signal.

In embodiments of the present application, unlocking information is obtained. The unlocking information is converted into a flashing sequence, and a light-emitting component is controlled to execute the flashing sequence. The light-emitting component is used to execute a flashing action. The status of a flash-receiving apparatus changes under the influence of a flashing signal generated by the light-emitting component, and an unlocking apparatus unlocks a to-be-unlocked object based on the status change, so as to achieve the objective of implementing unlocking of the to-be-unlocked object without using a communication module, achieving the technical effect of reducing cost and further solving the technical problem of higher cost due to the need to provide the vehicle with a radio frequency communication module.

Optionally, the flashing sequence further includes at least one of: an error correction code, a check code, and a digital signature. In the conversion process, some error correction codes (such as Reed Solomon) or the check code (such as CRC (Cyclic Redundancy Check)) or even a cryptographic signature can be included so as to ensure that the transmission process is intact.

Methods 200, 300, and 400 may be executed in a mobile terminal, a computer terminal, or a similar computing device. In addition, methods 200, 300, and 400 can be widely applied to the Internet. With the popularity of sharing economy, such as the popularity of sharing bikes, electric vehicles, power banks and even cars, and with the rapid development of Internet technology, most people unlock items by using their smart devices, particularly their smart phones.

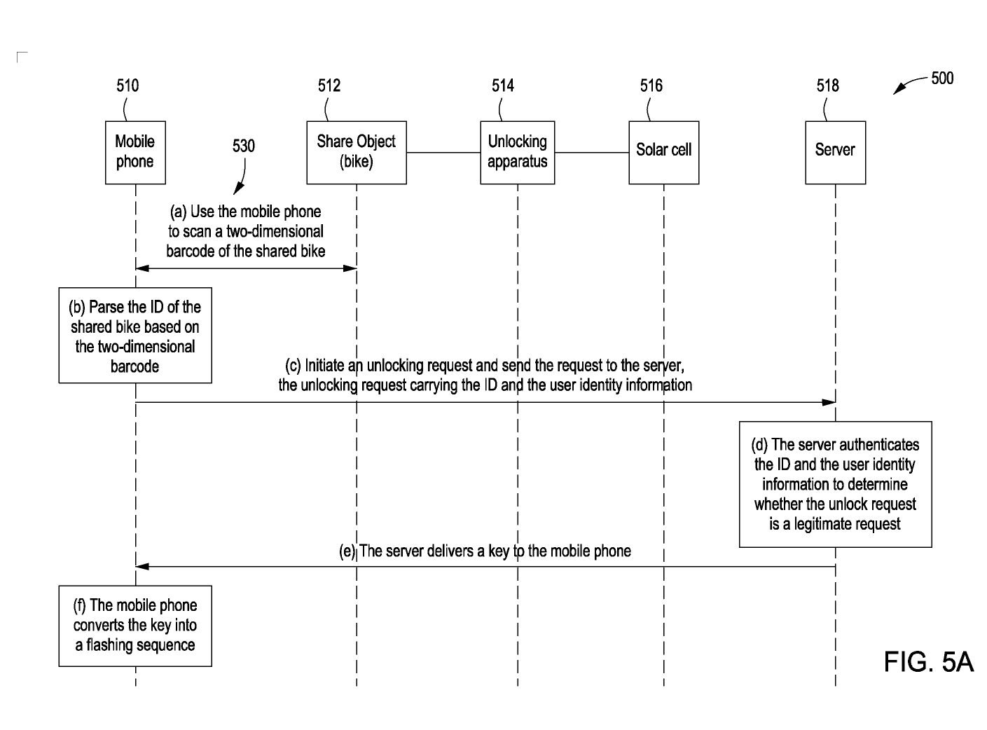

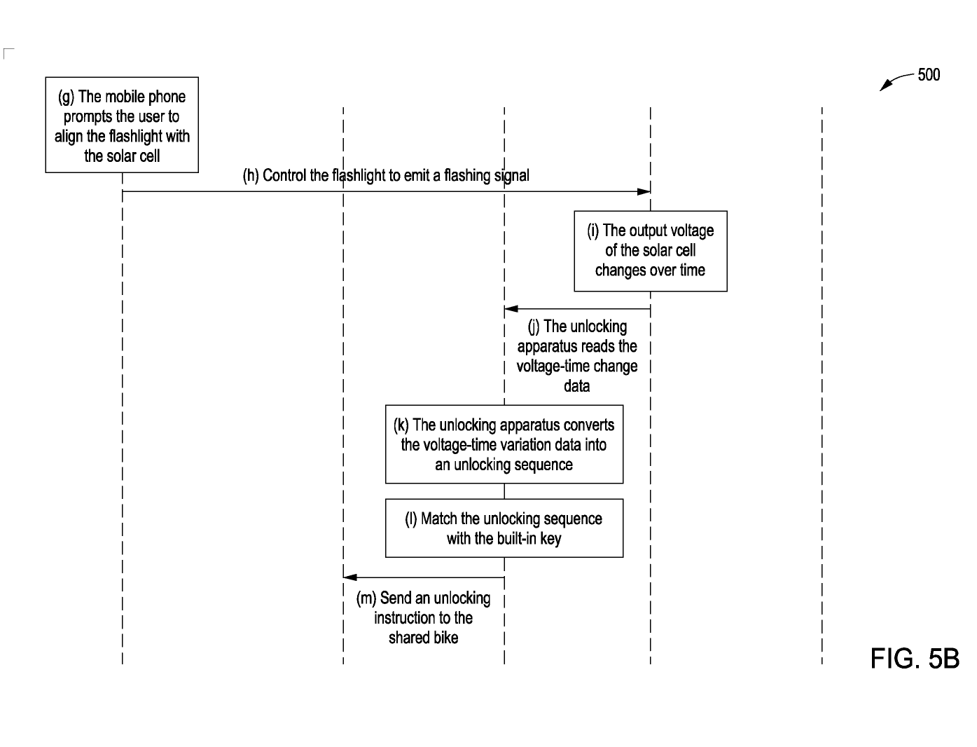

FIGS. 5A-5B show a block-flow diagram that illustrates an example of the interaction of a system 500 with a method 530 of unlocking an object in system 500 in accordance with the present invention. As shown in FIGS. 5A-5B, a system 500 includes a mobile phone 510, an object 512, an unlocking apparatus 514 coupled to object 512, a solar cell 516 coupled to unlocking apparatus 514, and a server 518 coupled to mobile phone 510. In this example, the flashlight of mobile phone 510 functions as the light-emitting component, object 512 functions as the to-be-unlocked object, and solar cell 516 functions as the flash-receiving apparatus.

As shown in FIGS. 5A-5B, method 530 begins at (a) by scanning a two-dimensional barcode on object 512 (e.g., a bike) using mobile phone 510. When the user wants to use the bike, the user needs to unlock the bike first. The user scans the two-dimensional code on the bike using mobile phone 510.

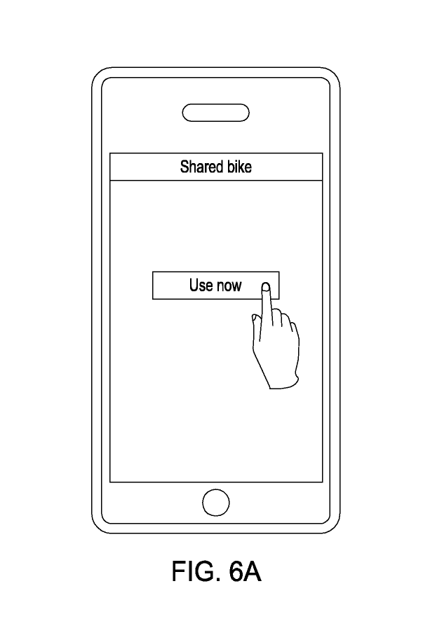

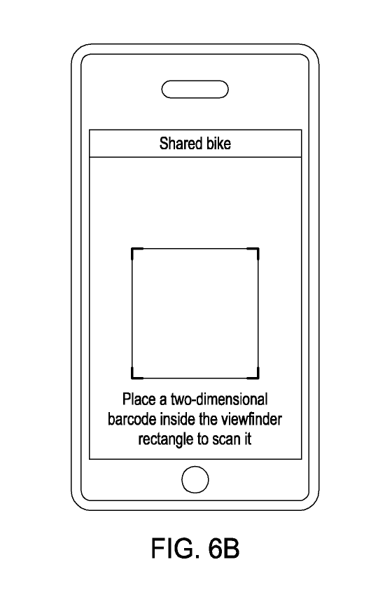

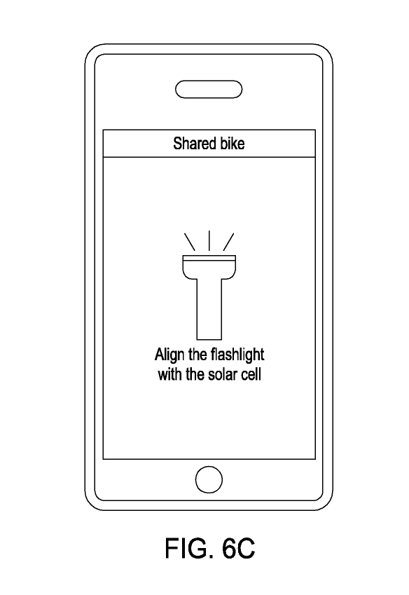

FIGS. 6A-6C show diagrams that illustrate an example of a mobile phone display 600 in accordance with the present invention. FIGS. 6A-6B illustrate display 600 while capturing a two-dimensional code. As shown in FIG. 6A, after the user clicks on the “use now” button, the mobile phone prompts the user to align the phone with the two-dimensional code for scanning, as shown in FIG. 6B.

Referring back to FIGS. 5A-5B, after scanning the two-dimensional code, method 530 moves to (b) to parse the ID of object 512 (bike) based on the two-dimensional barcode. After mobile phone 510 scans and obtains the two-dimensional barcode, the bike ID is parsed according to the two-dimensional barcode. Each bike only corresponds to one ID.

Next, method 530 to moves to (c) to initiate an unlocking request and send the request to server 518. The unlocking request carrys the ID and the user identity information. After parsing the ID of the bike, mobile phone 510 obtains the user identity information, and initiates an unlock request. The unlock request carries the ID and user identity information. The user identity information may include a user name, account information, and the like.

Following this, method 530 moves to (d) where server 518 receives the unlocking information that carrys the object ID and the user identity information, and authenticates the object ID and the user identity information to determine whether the unlock request is a legitimate request. For example, server 518 verifies whether the user has a right to unlock object 512 (the bicycle).

If the unlocking request is legitimate, method 530 moves to (e). If the unlocking request is not legitimate, server 518 returns a failure message to mobile phone 510. In (e), when server 518 determines that the unlocking request is a legitimate request, server 518 sends a digital key to object 512 (the bike) to mobile phone 510.

Next, method 530 moves to (f) where mobile phone 518 converts the digital key into a flashing sequence. In (f), Morse Code is used as an example, and the key is assumed to be 3271. According to a preset rule, it is determined that the corresponding flashing sequence for “3” is “...--”; the corresponding flashing sequence for “2” is “..---”; the corresponding flashing subsequence for “7” is “--...”; and the corresponding flashing sequence for “1” is “.----”. On such basis, the flashing sequence corresponding to the key may be generated as follows:

“...--

..---

--..

.----”

“.” indicates a short light pulse such as 10 ms. “-” indicates a light pulse that lasts for a longer time such as 30 ms. An interval between “.” and “-” may be 10 ms, and an interval between digitals may be 30 ms. The light pulse refers to a flashing action of the flashlight.

In addition, pulse number modulation may also be used. The key 3271 is still used as an example. The converted flashing sequence is as follows:

“...

..

.......

.”

Each “.” represents a light pulse that lasts, for example, for 10 ms, and the interval between each set of numbers is 30 ms. Other approaches for converting a key into a flash sequence output from a light-emitting component can alternately be used.

After this, method 530 moves to (g) where mobile phone 510 prompts the user to align the flashlight with the solar cell. FIG. 6C illustrates display 600 with an alignment screen. After the key has been converted into a flashing sequence, as shown in FIG. 6C, mobile phone 510 prompts the user to align the flashlight with the solar cell.

Method 530 next moves to (h) to control the flashlight to emit a flashing signal. In (h), mobile phone 510 controls the flashlight to emit a flashing signal with a flashing duration according to the flash frequency, wherein the flashing sequence includes the flashing frequency and the flashing duration.

Following this, method 530 moves to (i) where the output voltage of solar cell 516 changes in response to the flashing signal. Under the influence of the flashlight, the output voltage of solar cell 516 changes in response to the flashing signal. For example, once the flashlight is used to illuminate, the output voltage of solar cell 516 may change abruptly. For example, a high-level voltage may be output.

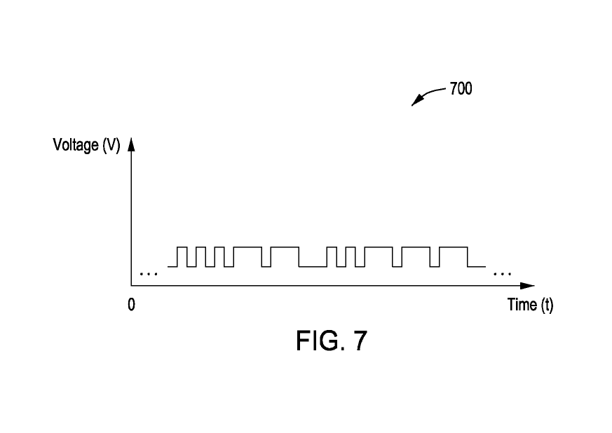

FIG. 7 shows a timing diagram that illustrates an example of a voltage (V)-time (t) graph 700 in accordance with the present invention. As shown in FIG. 7, the flashing signal causes solar cell 516 to output a pulse train where the pulses have varying widths and varying pulse-to-pulse spacing.

Referring again to FIGS. 5A-5B, method 530 next moves to (j) where unlocking apparatus 514 reads the voltage-time change data from solar cell 516. Unlocking apparatus 514 can, for example, read the voltage-time change data outputted by solar cell 516 through a low-pass filter circuit.

Method 530 then moves to (k) where unlocking apparatus 514 converts the voltage (V)-time (t) variation data into an unlocking sequence (e.g., the digital key sent by server 518). The unlocking sequence is parsed based on the voltage (V)-time (t) change data.

Following this, method 530 moves to (l) where unlocking apparatus 514 matches the unlocking sequence with the built-in key. Unlocking apparatus 514 pre-stores the unlocking key (i.e., the built-in key) for object 512 (bicycle). After obtaining the unlocking sequence, the unlocking sequence may be matched with the built-in key to determine whether they are the same.

If they match successfully (i.e., the unlocking sequence and the built-in key are the same), method 530 moves to (m). If the match fails (i.e., the unlocking sequence and the built-in key are different), a prompt message (such as a beep or voice) may be sent to indicate that the match has failed.

Unlocking apparatus 514 can directly convert the voltage (V)-time (t) change data into the unlocking sequence that includes the key. Alternately, unlocking apparatus 514 can first convert the voltage (V)-time (t) change data into an unlocking sequence similar to the flashing sequence, and then convert the unlocking sequence into a key. In (m), unlocking apparatus 514 sends an unlocking instruction to object 512 (bike) to unlock object 512.

One of the advantages of the present invention is that the user does not need to manually input a key to unlock the object. As a result, the object does not need to have a key input button. Another advantage is that the server does not need to be connected to the object through radio frequency communication. Instead, a much less expensive solar cell (or similar light detecting device) can be used in place of a radio frequency communication module, thereby achieving the goal of lowering the cost.

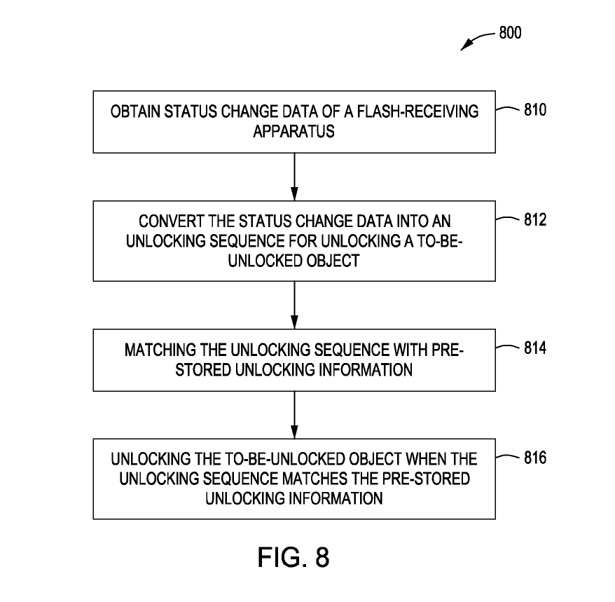

FIG. 8 shows a flowchart of an example of a method 800 of generating an unlocking instruction in accordance with the present invention. As shown in FIG. 8, method 800 begins at 810 where an unlocking apparatus obtains status change data (e.g., the voltage (V)-time (t) change data) from a flash-receiving device. The status change data is generated after the flash-receiving device receives a flashing signal from a light-emitting component. The flash-receiving device may include, for example, a solar cell, a photodiode, or a camera. The light-emitting component may include, for example, a flashlight of a mobile phone.

When the flash-receiving apparatus includes the solar cell, the status change data includes a voltage change data outputted by the solar cell. As shown in FIG. 7, under the influence of the light-emitting component, the output voltage of the solar cell may change over time. For example, once the light-emitting component is used to illuminate, the output voltage of the solar cell may change abruptly to a high-level voltage.

When the flash-receiving apparatus includes the photodiode, the status change data includes a change value of a reverse output voltage of the photodiode. Under the influence of the light-emitting component, the reverse output voltage of the photodiode will change over time.

When the flash-receiving apparatus includes a camera, the status change data includes a luminance change value detected by the camera. Under the influence of the light-emitting component, the luminance detected by the camera changes over time. For example, once the light-emitting component emits light, the camera detects a pure white image.

After this, method 800 moves to 812 to convert the status change data into an unlocking sequence for unlocking a to-be-unlocked object. After the status change data is obtained, the status change data may be converted into an unlocking sequence. Optionally, the status change data can be converted into the unlocking sequence through a low-pass filter circuit.

After the status change data has converted into the unlocking sequence, method 800 moves to 814 to match the unlocking sequence with pre-stored unlocking information. Following this, method 800 moves to 816 to unlock the to-be-unlocked object when the unlocking sequence matches the pre-stored unlocking information successfully. Matching the unlocking sequence includes extracting an unlocking key from the unlocking sequence, determining whether the unlocking key and a preset key in the pre-stored unlocking information are the same, and determining a match when the unlocking key and the preset key are the same.

The method of extracting the unlocking key from the unlocking sequence may include looking up the conversion table as shown in Table 1 to find the unlocking key for the unlocking sequence object. The Morse Code is still used as an example. The unlocking sequence may include at least one character. According to a preset rule, a plurality of characters correspond to one number, and the unlocking key may be extracted from the unlocking sequence.

If the unlock sequence matches the pre-stored unlock information successfully, an unlocking instruction is sent to unlock the to-be-unlocked object. In this embodiment, status change data of a flash-receiving apparatus is obtained, and the status change data is converted into an unlocking sequence for unlocking a to-be-unlocked object. The light-emitting component is used to execute a flashing action. The status of a flash-receiving apparatus changes under the influence of a flashing signal generated by the light-emitting component. An unlocking apparatus unlocks a to-be-unlocked object based on the status change. As a result, the objective of implementing unlocking of the to-be-unlocked object without using a radio frequency communication module is achieved, thereby achieving the technical effect of reducing cost and further solving the technical problem of higher cost due to the need to provide the object with a radio frequency communication module.

Through the description of the embodiments, a person skilled in the art can clearly understand that the methods according to the present invention can be implemented by means of software plus a necessary general hardware platform. Certainly, the hardware can also be used, but the former is a better implementation in many cases. Based on such understanding, the part of the technical solution of the present application that essentially contributes to the prior art may be embodied in the form of a software product. The computer software product is stored in a storage medium (such as ROM/RAM, a disk, and an optical disc etc.), including instructions for enabling a terminal device (which may be a mobile phone, a computer, a server, or a network device, etc.) to perform the methods described in the embodiments of the present application.

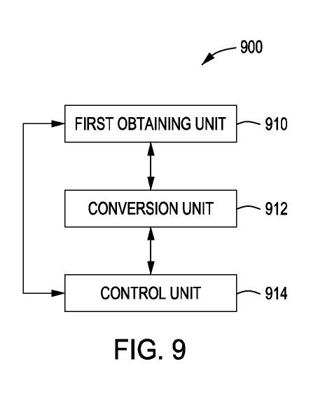

FIG. 9 shows a block diagram that illustrates an example of a unlocking apparatus 900 in accordance with the present invention. As shown in FIG. 9, unlocking apparatus 900 includes: a first obtaining unit 910, a conversion unit 912, and a control unit 914.

First obtaining unit 910 obtains unlocking information. Conversion unit 912 converts the unlocking information into a flashing sequence. Control unit 914 controls a light-emitting component to execute the flashing sequence. First obtaining unit 910, conversion unit 912, and control unit 914 correspond to 210 to 214 in FIG. 2. Examples implemented by the three modules and application scenarios are the same, but are not limited to the content disclosed in FIG. 2. It should be noted that the modules can operate in mobile terminal 100 provided in FIG. 1 as part of the apparatus.

First obtaining unit 910 is configured to execute the following steps to obtain unlocking information: obtaining identification information of a to-be-unlocked object; sending an unlocking request to a server, wherein the unlocking request carries the identification information and user identity information; the server generates the unlocking information when it is determined, based on the identification information and the user identity information, that the unlocking request is a legitimate request; and receiving the unlocking information returned by the server.

Optionally, conversion unit 912 can execute the following steps to convert the unlocking information to the flashing sequence: obtaining a key from the unlocking information; and generating the flashing sequence corresponding to the key according to a preset conversion table.

Optionally, control unit 914 can perform the following steps to control the light emitting component to execute the flashing sequence: controlling the light-emitting component to emit a flashing signal with a flashing duration according to a flashing frequency; the flashing sequence comprises the flashing frequency and the flashing duration. Optionally, the flashing sequence can further include at least one of: an error correction code, a check code, and a digital signature.

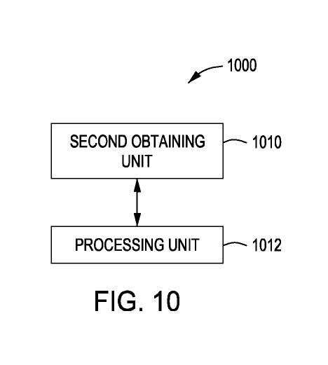

FIG. 10 shows a block diagram that illustrates an example of an unlocking apparatus 1000 in accordance with the present invention. As shown in FIG. 10, unlocking apparatus 1000 includes a second obtaining unit 1010 and a processing unit 1012. Second obtaining unit 1010 obtains status change data of a flash-receiving apparatus. Processing unit 1012 converts the status change data into an unlocking sequence for unlocking a to-be-unlocked object.

Second obtaining unit 1010 and processing unit 1012 correspond to 810 to 812 in FIG. 8. Examples implemented by the two modules and application scenarios are the same, but are not limited to the content disclosed in FIG. 8. The modules can operate in mobile terminal 100 provided in FIG. 1 as part of the apparatus.

Optionally, the flash-receiving apparatus includes a solar cell, a photodiode, or a camera. Optionally, when the flash-receiving apparatus includes the solar cell, the status change data includes a voltage change value outputted by the solar cell. When the flash-receiving apparatus includes the photodiode, the status change data includes a change value of a reverse output voltage of the photodiode. When the flash-receiving apparatus includes the camera, the status change data includes a luminance change value detected by the camera.

Optionally, processing unit 1012 converts the status change data into the unlocking sequence through a low-pass filter circuit. Optionally, the unlocking apparatus further includes: a matching unit, configured to match the unlocking sequence with pre-stored unlocking information, and an unlocking unit, configured to unlock the to-be-unlocked object when the unlocking sequence matches the pre-stored unlocking information successfully.

Optionally, the matching unit executes the following steps to match the unlocking sequence with the pre-stored unlocking information: extracting an unlocking key from the unlocking sequence; determining whether the unlocking key and a preset key in the pre-stored unlocking information are the same; and if the unlocking key and the preset key are the same, determining that the unlocking sequence matches the pre-stored unlocking information successfully. Optionally, the status change data is generated after the flash-receiving apparatus receives a flashing signal of a light-emitting component.

In accordance with the present invention, a terminal for implementing the unlocking method is further provided. The terminal includes a light-emitting component and a processor. The processor runs a program that executes the following processing steps when running: obtaining unlocking information; converting the unlocking information into a flashing sequence; and controlling a light-emitting component to execute the flashing sequence.

Optionally, the processor may further execute program codes of the following steps: obtaining identification information of a to-be-unlocked object; sending an unlocking request to a server, wherein the unlocking request carries the identification information and user identity information; the server generates the unlocking information when it is determined, based on the identification information and the user identity information, that the unlocking request is a legitimate request; and receiving the unlocking information returned by the server.

Optionally, the processor may also execute the program codes of the following steps: obtaining a key from the unlocking information; and generating the flashing sequence corresponding to the key according to a preset conversion table. Optionally, the processor may also execute the program codes of the following steps: controlling the light-emitting component to emit a flashing signal with a flashing duration according to a flashing frequency; the flashing sequence comprises the flashing frequency and the flashing duration.

An unlocking device for implementing the unlocking method is further provided. The unlocking device includes a flash-receiving apparatus and a processor. The processor runs a program that executes the following processing steps on data outputted by the flash-receiving apparatus: obtaining status change data of the flash-receiving apparatus; and converting the status change data into an unlocking sequence for unlocking a to-be-unlocked object.

Optionally, the processor may also execute the program code of the following step: converting the status change data into the unlocking sequence through a low-pass filter circuit. Optionally, the processor may also execute the program codes of the following steps: matching the unlocking sequence with pre-stored unlocking information; and unlocking the to-be-unlocked object when the unlocking sequence matches the pre-stored unlocking information successfully.

Optionally, the processor may further execute the program codes of the following steps: extracting an unlocking key from the unlocking sequence; determining whether the unlocking key and a preset key in the pre-stored unlocking information are the same; and if the unlocking key and the preset key are the same, determining that the unlocking sequence matches the pre-stored unlocking information successfully.

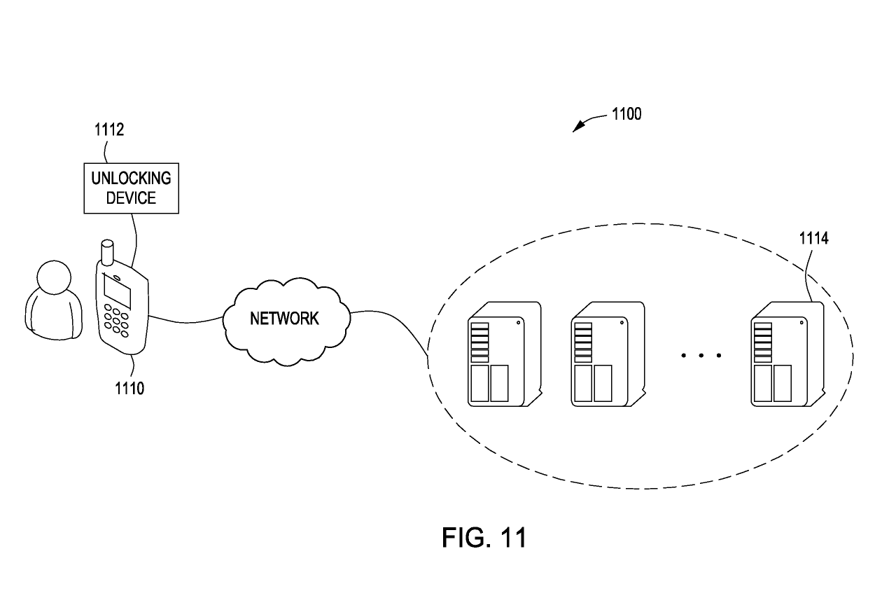

FIG. 11 shows a diagram that illustrates an example of an unlocking system 1100 in accordance with the present invention. As shown in FIG. 11, the system includes a terminal 1110 and an unlocking device 1112. Terminal 1110 obtains unlocking information, converts the unlocking information into a flashing sequence, controls a light-emitting component to execute the flashing sequence. Unlocking device 1112 obtains status change data of a flash-receiving apparatus, and converts the status change data into an unlocking sequence for unlocking a to-be-unlocked object.

Optionally, as shown in FIG. 11, unlocking system 1100 further includes a server 1114 to receive an unlocking request sent by terminal 1110. The unlocking request carries identification information of the to-be-unlocked object and user identity information. Server 1114 also determines, based on the identification information and the user identity information, whether the unlocking request is legitimate. In addition, server 1114 generates the unlocking information when it is determined, based on the identification information and the user identity information, that the unlocking request is legitimaghe, and returns the unlocking information to terminal 1110.

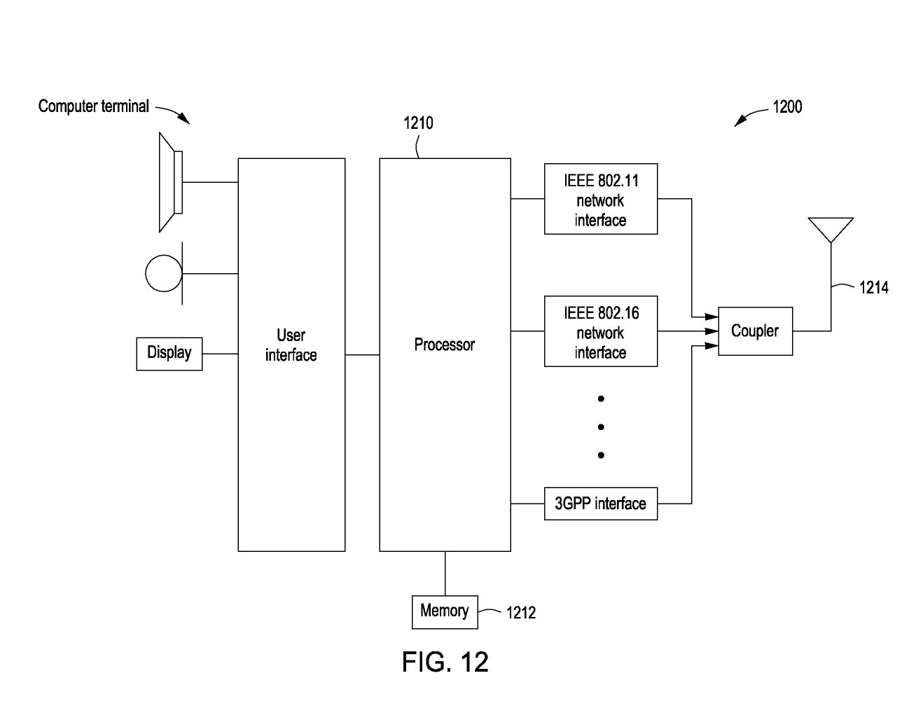

FIG. 12 shows a block diagram that illustrates an example of a computer terminal 1200 in accordance with the present invention. As shown in FIG. 12, computer terminal 1200 includes a processor 1210, a memory 1212, and a transmission apparatus 1214. Processor 1210 may invoke, through transmission apparatus 1214, information and application software stored in the memory to execute the following steps: obtaining unlocking information; converting the unlocking information into a flashing sequence; and controlling a light-emitting component to execute the flashing sequence.

Optionally, processor 1210 may further execute program codes of the following steps: obtaining identification information of a to-be-unlocked object; sending an unlocking request to a server, wherein the unlocking request carries the identification information and user identity information; the server generates the unlocking information when it is determined, based on the identification information and the user identity information, that the unlocking request is a legitimate request; and receiving the unlocking information returned by the server.

Optionally, processor 1210 may also execute the program codes of the following steps: obtaining a key from the unlocking information; and generating the flashing sequence corresponding to the key according to a preset conversion table. Optionally, processor 1210 may also execute the program codes of the following steps: controlling the light-emitting component to emit a flashing signal with a flashing duration according to a flashing frequency; the flashing sequence comprises the flashing frequency and the flashing duration.

Processor 1210 may invoke, through transmission apparatus 1214, information and application software stored in memory 1212 to execute the following steps: obtain status change data of a flash-receiving apparatus; and convert the status change data into an unlocking sequence for unlocking a to-be-unlocked object. Optionally, processor 1210 may also execute the program code of the following step: converting the status change data into the unlocking sequence through a low-pass filter circuit.

Optionally, processor 1210 may also execute the program codes of the following steps: matching the unlocking sequence with pre-stored unlocking information; and unlocking the to-be-unlocked object when the unlocking sequence matches the pre-stored unlocking information successfully. Optionally, processor 1210 may further execute the program codes of the following steps: extracting an unlocking key from the unlocking sequence; determining whether the unlocking key and a preset key in the pre-stored unlocking information are the same; and if the unlocking key and the preset key are the same, determining that the unlocking sequence matches the pre-stored unlocking information successfully.

Memory 1212 can be used for storing software applications and modules such as the program instructions/modules corresponding to the unlocking method and apparatus. Processor 1210 runs software programs and modules stored in memory 1212, so as to execute various applications and data processing, i.e., implement the unlocking method. Memory 1212 may include a high-speed random access memory, and may also include a non-volatile memory such as one or more magnetic storage devices, flash memory, or other non-volatile solid-state memories. In some examples, memory 1212 may further include memories remotely arranged with respect to the processor. The remote memories may be connected to the mobile terminal via a network. Examples of such networks include, but are not limited to, the Internet, intranets, local area networks, mobile communication networks, and the combinations thereof.

Computer terminal 1200 may be any computer terminal device in a computer terminal group. Optionally, computer terminal 1200 may be replaced with a terminal device such as a mobile terminal. Optionally, computer terminal 1200 may be located in at least one network device in a plurality of network devices of a computer network. Computer terminal 1200 may execute the program codes in the unlocking method of an application with the following steps: obtaining unlocking information; converting the unlocking information into a flashing sequence; and controlling a light-emitting component to execute the flashing sequence.

In embodiments of the present application, unlocking information is obtained, the unlocking information is converted into a flashing sequence, and a light-emitting component is controlled to execute the flashing sequence. The light-emitting component is used to execute a flashing action. The status (output) of a flash-receiving apparatus changes under the influence of a flashing signal generated by the light-emitting component, and an unlocking apparatus unlocks a to-be-unlocked object based on the status change, so as to achieve the objective of implementing unlocking of the to-be-unlocked object without using a communication module, thereby achieving the technical effect of reducing cost and further solving the technical problem of higher cost due to the need to provide the vehicle with a radio frequency communication module.

A person skilled in the art can understand that the structure shown in FIG. 12 is merely illustrative; and computer terminal 1200 may also be a smart phone (such as an Android mobile phone, an iOS mobile phone, etc.), tablets, pocket PCs, and mobile Internet devices (MIDs), PADs, and other terminal devices. FIG. 12 does not limit the structure of the electronic apparatus. For example, computer terminal 1200 may also include more or fewer components than those shown in FIG. 12 (e.g., a network interface or a display device), or have a different configuration than that shown in FIG. 12.

A person skilled in the art can understand that all or some of the various methods in the above embodiments can be completed through a program instructing the hardware related to a terminal device. The program can be stored in a computer-readable storage medium, and the storage medium can be a flash disk, a Read-Only Memory (ROM), a Random Access Memory (RAM), a disk or an optical disk.

An embodiment of the present invention further provides a storage medium. Optionally, in this embodiment, the storage medium may be used for storing the program code executed by the unlocking method provided in method 200. Optionally, in this embodiment, the storage medium may be located in any computer terminal in a computer terminal group of a computer network, or located in any mobile terminal in a mobile terminal group.

Optionally, in this embodiment, the storage medium is also configured to store program codes used to execute the following steps: obtaining unlocking information; converting the unlocking information into a flashing sequence; and controlling a light-emitting component to execute the flashing sequence.

An embodiment of the present application further provides a storage medium. Optionally, in this embodiment, the storage medium may be used for storing the program code executed by the unlocking method provided in method 800. Optionally, in this embodiment, the storage medium may be located in any computer terminal in a computer terminal group of a computer network, or located in any mobile terminal in a mobile terminal group.

Optionally, in this embodiment, the storage medium is also configured to store program codes used to execute the following steps: obtaining status change data of a flash-receiving apparatus in a preset time period, wherein the status change data is generated after the flash-receiving apparatus receives a flashing signal of a light-emitting component; converting the status change data into a unlocking sequence; matching the unlocking sequence with pre-stored unlocking information; and unlocking the to-be-unlocked object when the unlocking sequence matches the pre-stored unlocking information successfully.

The sequence numbers of the foregoing embodiments of the present invention are merely for description and they do not imply the preference among the embodiments.

In the embodiments of the present application, the description of each embodiment has its own focus. For the part not described in detail in one embodiment, reference can be made to the relevant description of other embodiments.

In the several embodiments provided by the present application, it should be understood that the disclosed technical content may be implemented in other manners. The apparatus embodiment described above is merely illustrative. For example, the division of the units is merely a logical function division. Other division methods in practical implementation may exist, like a plurality of units or components can be combined or can be integrated into another system, or some features can be ignored or are not executed. Additionally, the intercoupling, direct coupling, or communication connection displayed or discussed may be electrical or other forms through some interfaces, indirect coupling or communication connection of the units or the modules.

The units described as separate parts may or may not be physically separated, and the parts shown as units may or may not be physical units, which may be located in one place or may be distributed onto a plurality of network units. The objective of the solution of this embodiment may be implemented by selecting a part of or all the units according to actual requirements.

In addition, various functional units in the embodiments of the present application may be integrated in one processing unit, or the units exist physically and separately, or two or more units are integrated in one unit. The integrated unit may be implemented by using hardware, and may also be implemented in a form of a software functional unit.

The integrated unit, if implemented in the form of a software functional unit and sold and sold or used as an independent product, may be stored in a computer-readable storage medium. Based on such understanding, the part of the technical solution of the present invention that is essentially or contributing to the prior art or all or part of the technical solution may be embodied in the form of a software product; and the software product is stored in a storage medium, including several instructions for enabling a computer device (which may be a personal computer, a server, a network device, etc.) to perform all or part of the steps of the methods described in the various embodiments of the present invention. The storage medium includes: an USB flash disk, a read-only memory (ROM), a random access memory (RAM), a mobile hard disk drive, a magnetic disk, an optical disk, or any other medium that can store program codes.

The above description includes only preferred embodiments of the present invention. It should be noted that a person skilled in the art can also make several improvements and modifications without deviating from the principle of the present invention. These improvements and modifications are seen as falling within the protection scope of this present invention. The above descriptions are merely preferred embodiments of the present invention. It should be pointed out that those of ordinary skill in the art can make several improvements and modifications without departing from the principle of the present invention, and the improvements and modifications should also be construed as falling within the protection scope of the present invention.

What is claimed is:

1. An unlocking system comprising:
a mobile computing device that obtains unlocking information, converts the unlocking information into a flashing sequence, and controls a light-emitting component of the mobile computing device to output the flashing sequence as a flashing light sequence;
a flash detecting device that detects the flashing light sequence, and outputs a flashing signal that varies in response to the flashing light sequence; and
an unlocking device coupled to the flash detecting device to receive the flashing signal, extract a digital key from the flashing signal, compare the digital key to a prestored digital key, and output an unlock signal when the digital key matches the prestored digital key.

2. The unlocking system according to claim 1, wherein to obtain unlocking information, the mobile computing device to:
obtain identification information of a to-be-unlocked object;
send an unlocking request to a server, the unlocking request including the identification information and user identity information; and
receive the unlocking information from the server when the server determines that the unlocking request is legitimate based on the identification information and the user identity information.

3. The unlocking system according to claim 2, wherein to convert the unlocking information into a flashing sequence, the mobile computing device to:
obtain a key from the unlocking information; and
generate the flashing sequence corresponding to the key according to a preset conversion table.

4. The unlocking system according to claim 3, wherein the flashing sequence includes a flashing signal with a flashing duration according to a flashing frequency, wherein the flashing sequence comprises the flashing frequency and the flashing duration.

5. The unlocking system according to claim 3, wherein the flash-detecting device is a solar cell, and the flashing signal is a voltage change value output by the solar cell.

6. The unlocking system according to claim 3, wherein the flash-detecting device is a photodiode, and the flashing signal is a change value of a reverse output voltage output by the photodiode.

7. The unlocking system according to claim 3, wherein the flash-detecting device is a camera, and the flashing signal is a luminance change value detected by the camera.

8. An unlocking method, comprising:
obtaining unlocking information;
converting the unlocking information into a flashing sequence; and
controlling a light-emitting component to output the flashing sequence as a flashing light sequence.

9. The unlocking method according to claim 8, wherein obtaining unlocking information includes:
obtaining identification information of a to-be-unlocked object;
sending an unlocking request to a server, the unlocking request including the identification information and user identity information; and
receiving the unlocking information from the server when the server determines that the unlocking request is legitimate based on the identification information and the user identity information.

10. The unlocking method according to claim 9, wherein converting the unlocking information into a flashing sequence includes:
obtaining a key from the unlocking information; and
generating the flashing sequence corresponding to the key according to a preset conversion table.

11. The unlocking method according to claim 10, wherein the flashing sequence includes a flashing signal with a flashing duration according to a flashing frequency, wherein the flashing sequence comprises the flashing frequency and the flashing duration.

12. The unlocking method according to claim 11, wherein the flashing sequence further includes one or more of: an error correction code, a check code, and a digital signature.

14. The unlocking method according to claim 8, further comprising detecting the flashing light sequence, and outputting a flashing signal that varies in response to the flashing light sequence.

15. The unlocking method according to claim 14, further comprising receiving the flashing signal, extracting a digital key from the flashing signal, comparing the digital key to a pre-stored digital key, and outputting an unlock signal when the digital key matches the pre-stored digital key.

16. A non-transitory computer-readable storage medium having embedded therein program instructions, which when executed by a processor causes the processor to execute a method of unlocking an object, the method comprising:
detecting a flashing light sequence, and outputting a flashing signal that varies in response to the flashing light sequence; and
receiving the flashing signal, extracting a digital key from the flashing signal, comparing the digital key to a pre-stored digital key, and outputting an unlock signal when the digital key matches the pre-stored digital key.

17. The medium according to claim 16, wherein the method further comprises unlocking the object in response to the unlock signal.

18. The medium according to claim 17, wherein the flash-detecting device is a solar cell, and the flashing signal is a voltage change value output by the solar cell.

19. The medium according to claim 17, wherein the flash-detecting device is a photodiode, and the flashing signal is a change value of a reverse output voltage output by the photodiode.

20. The medium according to claim 17, wherein the flash-detecting device is a camera, and the flashing signal is a luminance change value detected by the camera.
